(19) United States
(12) Patent Application Publication
(10) Pub. No.: US 2025/0062513 A1
(43) Pub. Date: Feb. 20, 2025

(54) UNIVERSALLY COMPATIBLE, MULTIFUNCTIONAL SAFETY LAYER FOR BATTERY CELL

(71) Applicant: AMERICAN LITHIUM ENERGY CORPORATION, Carlsbad, CA (US)

(72) Inventors: Jiang FAN, Carlsbad, CA (US); Christopher KOMPELLA, Carlsbad, CA (US)

(21) Appl. No.: 18/715,483

(22) PCT Filed: Dec. 2, 2022
(86) PCT No.: PCT/US2022/051724

§ 371 Date: May 31, 2024

Related U.S. Application Data
(60) Provisional application No. 63/285,651, filed on Dec. 3, 2021.

(51) Int. Cl. H01M 50/574; H01M 4/66

(52) U.S. Cl. CPC H01M 50/574; H01M 4/661

(57) ABSTRACT

A battery cell may include an electrolyte, a first electrode, a second electrode, and a separator interposed between the first electrode and the second electrode. One or both of the first electrode and the second electrode may include a multifunctional safety layer interposed between an electrode layer and a current collector. The multifunctional safety layer may include a protective layer and a safety layer. The safety layer may respond to a first trigger by interrupting current flow within the battery cell. The protective layer may prevent a reaction between the safety layer and the electrolyte and/or the electrode layer of the battery cell. The protective layer may respond to a second trigger by exposing the safety layer to the electrolyte and/or the electrode layer of the battery cell. The resulting physical and/or chemical reactions may interrupt the current flow in the battery cell.

### CROSS REFERENCE TO RELATED APPLICATIONS

This application claims priority to U.S. Provisional Application No. 63/285,651, entitled “UNIVERSALLY COMPATIBLE, MULTIFUNCTIONAL SAFETY LAYER FOR BATTERY CELL” and filed on Dec. 3, 2021, the disclosure of which is incorporated herein by reference in its entirety.

### TECHNICAL FIELD

The subject matter described herein relates generally to battery cells and more specifically to a universally compatible, multifunctional safety layer for use in battery cells.

### BACKGROUND

A battery cell can overcharge, overheat, and/or short circuit during operation. For example, an overcurrent can occur when the battery cell is overcharged and/or develops an internal short circuit. Overcurrent can cause irreversible damage to the battery cell. In particular, overcurrent can lead to thermal runaway, a hazardous condition in which undissipated heat from the overheating battery cell accelerates exothermic reactions within the battery cell to further increase the temperature of the battery. The consequences of thermal runaway can be especially dire including, for example, fire, explosions, and/or the like.

### SUMMARY

Methods, systems, and articles of manufacture, including computer program products, are provided for a universally compatible, multifunctional safety layer for battery cell. In one aspect of the current subject matter, a battery cell may include a multifunctional layer configured to mitigate and/or eliminate the hazards that can arise during the operation of the battery cell. The multifunctional layer may include a safety layer and a protective layer. The multifunctional layer may be interposed between an electrode and a current collector of the battery cell, with the protective layer further being interposed between the electrode and the safety layer. The protective layer may isolate the safety layer from the other components of the battery cell in particular the electrodes and the electrolyte included in the battery cell. As such, the presence of the protective layer may lend flexibility to the choice of material used to form the safety layer. For example, the material forming the safety layer may be selected to maximize performance, with minimal consideration necessary for compatibility with the other components of the battery cell.

In another aspect, there is provided a battery cell that includes a multifunctional layer including a safety layer and a protective layer. The battery cell may include: an electrolyte; a first electrode including a first electrode layer and a first current collector, the first electrode further include a first protective layer and a first safety layer, the first protective layer interposed between the first electrode layer and the first safety layer, the first safety layer interposed between the first protective layer and the first current collector, the first safety layer configured to respond to a first trigger by at least interrupting a current flow within the battery cell, and the first protective layer configured to prevent a reaction between the first safety layer and the electrolyte and/or the first electrode layer of the battery cell until the first protective layer is activated by a second trigger; a second electrode including a second electrode layer and a second current collector; and a separator interposed between the first electrode and the second electrode.

In some variations of the methods, systems, and computer program products, one or more of the following features can optionally be included in any feasible combination.

In some variations, the second electrode may further include a second safety layer configured to respond to the first trigger by at least interrupting the current flow within the battery cell. The second electrode may further include a second protective layer configured to prevent a reaction between the second safety layer and the electrolyte and/or the second electrode layer of the battery cell until the second protective layer is activated by the second trigger.

In some variations, the second protective layer may be interposed between the second electrode layer and the second safety layer. The second safety layer may be interposed between the second protective layer and the second current collector.

In some variations, the first protective layer may be configured to respond to the second trigger by at least exposing the first safety layer to the electrolyte and/or the first electrode layer of the battery cell. The first safety layer may be further configured to interrupt the current flow within the battery cell upon being exposed to the electrolyte and/or the first electrode layer of the battery cell.

In some variations, the first safety layer may undergo a reaction with the electrolyte and/or the first electrode layer of the battery cell upon being exposed to the electrolyte and/or the first electrode layer of the battery cell.

In some variations, the reaction may include a physical reaction in which the first safety layer expands to create a nonconductive gap between the first electrode layer and the first current collector that interrupts the current flow within the battery cell.

In some variations, the reaction may include a chemical reaction in which the first safety layer decomposes to create a nonconductive gap between the first electrode layer and the first current collector that interrupts the current flow within the battery cell.

In some variations, the reaction may include a chemical reaction in which an ionic conductivity of the electrolyte is lowered to interrupt the current flow within the battery cell.

In some variations, at least a portion of the first protective layer may be configured to decompose in response to the second trigger. The first safety layer may be exposed to the electrolyte and/or the first electrode layer of the battery cell when at least the portion of the first protective layer decomposes in response to the second trigger.

In some variations, at least a portion of the first protective layer may be configured to shrink in response to the second trigger. The first safety layer may be exposed to the electrolyte and/or the first electrode layer of the battery cell when at least the portion of the first protective layer shrinks in response to the second trigger.

In some variations, the first trigger may be a different trigger or a trigger having a different threshold than the second trigger.

In some variations, the first trigger and the second trigger may each be a temperature trigger, a voltage trigger, a current trigger, or a physical damage to the battery cell.

In some variations, the second trigger may be a physical damage to the first protective layer while the first trigger may be a temperature trigger, a voltage trigger, and/or a current trigger.

In some variations, the first protective layer may be formed from one or more of poly (ethylene-co-vinyl acetate) (PECVA), styrene-butadiene rubber (SBR), Polytetrafluoroethylene (PTFE)), wax, silicon (Si) rubber, polyacrylic polymer, poly propylene, polyethylene, ethylene propylene diene monomer (EPDM) rubber and its analog, tire rubber, polyvinylidene fluoride (PVDF), polypropylene (PP atactic), polyvinyl fluoride (PVF), polypropylene (PP isotactic), poly-3-hydroxybutyrate (PHB), poly(vinyl acetate) (PVAc), polychlorotrifluoroethylene (PCTFE), polyamide (PA), metal foil, metal alloy foil, conductive polymer film, materials exhibiting a negative thermal expansion (NTE) coefficient, and materials that are reactive with the decomposition byproducts of electrolyte.

In some variations, the first electrode may be a positive electrode of the battery cell while the second electrode may be a negative electrode of the battery cell.

In some variations, the first current collector may be an aluminum (Al) current collector while the second current collector may be a copper (Cu) current collector.

In some variations, the first safety layer may include one or more of a hydrate, a carbonate, a fire extinguishing agent, and an organic salt exhibiting a below-threshold decomposition voltage and/or melting point.

In some variations, the first safety layer may include one or more of lithium acetate dihydrate (CH₃COOLi2H₂O), sodium metasilicate hydrate (Na₂SiO₃·9H₂O), and calcium chloride hydrate (CaCl₉H₂O).

In some variations, the battery cell may be a lithium (Li) ion battery cell, a sodium (Na) ion battery cell, an aluminum (Al) ion battery cell, or a magnesium (Mg) ion battery cell.

In some variations, the battery cell may be a cylindrical battery cell, a button battery cell, a prismatic battery cell, or a pouch battery cell.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a schematic diagram illustrating an example of an electrode having a multifunctional safety layer consistent with implementations of the current subject matter;

FIG. 2A depicts a schematic diagram illustrating an example of a battery cell having a multifunctional safety layer consistent with implementations of the current subject matter;

FIG. 2B depicts a schematic diagram illustrating an example of a battery cell having a protective layer that has decomposed due to exposure to high temperature, high current, high voltage, and/or physical damage to the battery cell consistent with implementations of the current subject matter;

FIG. 2C depicts a schematic diagram illustrating an example of a multifunctional safety layer having a metal foil protective layer that is activated by physical damage consistent with implementations of the current subject matter;

FIG. 2D depicts a schematic diagram illustrating an example of a multifunctional safety layer that is integrated with a current collector consistent with implementations of the current subject matter; and

FIG. 3 depicts a flowchart illustrating a process for assembling a battery cell consistent with implementations of the current subject matter.

When practical, like labels are used to refer to same or similar items in the drawings.

### DETAILED DESCRIPTION

A battery cell can include at least one safety layer to mitigate and/or eliminate the operational hazards of the battery cell including, for example, overcharging, overheating, short-circuiting, and/or the like. The overcharging, overheating, and/or short-circuiting of the battery cell can lead to thermal runaway, a dangerous condition in which the battery cell undergoes a precipitous increase in temperature. Accordingly, the safety layer can be configured to respond to an increase in temperature by interrupting a flow of current within the battery cell. For example, when the battery cell is exposed to temperatures exceeding a threshold value, the safety layer can undergo a phase transition that causes the safety layer to expand and/or contract. The expansion and/or contraction of the safety layer can cause an electric decoupling within the battery cell, for example, between an electrode of the battery cell and a corresponding current collector. The electric decoupling can interrupt the flow of current within the battery cell, thereby arresting exothermic reactions within the battery cell and any further increase in the temperature of the battery cell.

Exposing the safety layer to the other components of the battery cell, such as the electrodes and/or the electrolyte, may cause undesirable reactions including degradation of the safety layer, premature activation of the safety layer, and/or the like. For example, hydrates, such as lithium acetate dihydrate (CH₃COOLi2H₂O), sodium metasilicate hydrate (Na₂SiO₃·9H₂O), and calcium chloride hydrate (CaCl₉H₂O), exhibit a number of desirable properties including an ability to release water locally at the location of an internal short to eliminate the initiation of the hot spot immediately. However, a safety layer formed from hydrates such as lithium acetate dihydrate (CH₃COOLi2H₂O), sodium metasilicate hydrate (Na₂SiO₃·9H₂O), and calcium chloride hydrate (CaCl₉H₂O), carbonates, fire extinguish agents, and organic salts with below-threshold decomposition voltages or melting points like lithium (Li) or sodium acetate hydrate (CH₃COONa3H₂O), can react with the electrolyte or dissolve into the electrolyte under normal operation conditions. In other words, the materials forming a safety layer must be carefully selected in order to be compatible with the other components of a battery cell. However, this limitation in the choice of material could potentially compromise the performance of the safety layer because materials that are compatible with the other components of the battery cell do not necessarily provide the best performance such as high heat capacity or ability to undergo phase transitions.

In some implementations of the current subject matter, instead of a single safety layer, the battery cell may include a multifunction layer that includes a safety layer and a protective layer. The multifunction layer may be interposed between an electrode and a current collector of the battery cell, with the protective layer further being interposed between the electrode and the safety layer. The presence of the multifunction layer including the safety layer may improve the cell cycle and the high temperature stability of the battery cell. In some cases, the protective layer may be formed from one or more materials that are inert in the presence of the reactive components of the battery cell such as the electrodes and/or the electrolyte while remaining electrically conductive. For example, in some cases, the protective layer may be resistant to reacting with the electrolyte as well as the electrode materials of the battery cell. The presence of the protective layer, which remains stable when exposed to the electrolyte and electrode materials of the battery cell, may therefore lend flexibility in the choice of material forming the safety layer as the protective layer may prevent the safety layer from being exposed to the reactive components of the battery cell. Moreover, the presence of the protective layer may render the safety layer more tolerant to manufacturing processes (e.g., calendaring of the electrode and/or the like) as well as exposure to a high temperature environment such as during the coating and drying of the electrodes.

Configuring a single safety layer to respond to multiple triggers may be challenging. Contrastingly, the protective layer and the safety layer are configured to serve different purpose and may therefore be configured to activate upon different triggers such as, for example, a temperature trigger, a voltage trigger, a current trigger, physical damage to the battery cell or any components therein (e.g., due to penetration, deformation, and impact against the battery cell), and/or the like. For example, the protective layer may be configured to respond to a more precise trigger point (e.g., a first temperature threshold, a first voltage threshold, a first current threshold, a first physical damage, and/or the like) by exposing the safety layer whereas the safety layer may be configured to activate upon exposure and/or a less precise trigger point (e.g., a second temperature threshold, a second voltage threshold, a second current threshold, a second physical damage, and/or the like).

In some implementations of the current subject matter, while the safety layer may exhibit instability towards the other components of the battery cell (e.g., electrodes, electrolyte, and/or the like), the protective layer may be inert in the presence of these same components. For example, whereas the safety layer may become reactive in the presence of an electrolyte, the protective layer may be immiscible and thus provide a physical separation between the safety layer, and a corresponding electrode in the battery cell. During normal operation (e.g., in the absence of any triggers), the presence of the protective layer may prevent the safety layer from being exposed to the electrolyte and undergo an undesirable reaction. However, upon activation of a trigger associated with the protective layer (e.g., a temperature trigger, a voltage trigger, a current trigger, a physical damage to the battery cell or any components therein, and/or the like), the protective layer may disintegrate to expose the safety layer, at which point a suitable reaction may take place to prevent thermal runaway at the battery cell. The safety layer may also be exposed by the protective layer being broken due to application of mechanical stress.

This reaction may include a physical reaction (e.g., a swelling or other expansion of the safety layer) that causes an interruption in the electronic conduction pathway, akin to a positive temperature coefficient (PTC) composite. Alternatively and/or additionally, this reaction may include a chemical reaction such as a decomposition of the safety layer and/or a reaction between the electrode and the safety layer, which creates a nonconductive gap between the current collector and the electrode. This reaction may also include a chemical reaction between the safety layer and the electrolyte that lowers the ionic conductivity of the electrolyte.

In some implementations of the current subject matter, the protective layer may be polymeric and applied by one or more of a solution-based spraying, coating, vapor deposition, and/or the like. Alternatively and/or additionally, the protective layer may be metallic and applied by one or more of a metal evaporation, vapor deposition, and/or the like. Alternatively and/or additionally, the protective layer may be formed from monomers, which are crosslinked by exposure to heat, ultraviolet light, x-ray, laser, and/or the like. Alternatively and/or additionally, the protective layer may be formed from one or more conductive polymers and/or conductive ceramics (e.g., metal oxide, transition metal oxide, and/or the like). The protective layer may also be formed by sputtering and/or atomic layer deposition.

In some implementations of the current subject matter, the multifunction layer including the safety layer and the protective layer may be coated on one or both current collectors of the battery cell. Depending on the application, such as the format of the battery cell, one or more of the current collectors may be formed from a metal foil or the case of the battery cell.

In some implementations of the current subject matter, the protective layer may be optional. For example, the multifunction layer including the safety layer and the protective layer may be coupled with a first electrode of the battery cell whereas a second electrode of the battery cell may be coupled with the safety layer without the protective layer. The safety layer and the protective layer may be formed (e.g., by coating and/or the like) simultaneously and then formed in situ.

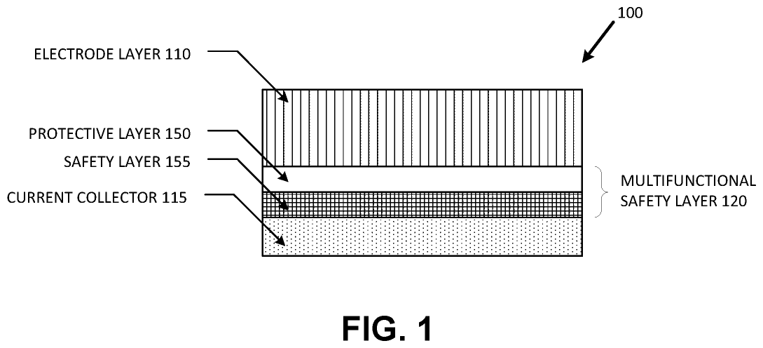

FIG. 1 depicts a schematic diagram illustrating an electrode 100 having an example of a multifunctional safety layer 120 consistent with implementations of the current subject matter. Referring to FIG. 1, the electrode 100 may include an electrode layer 110 and a current collector 115. The multifunctional safety layer 120, which includes a protective layer 150 and a safety layer 155, may be interposed between the electrode layer 110 and the current collector 115. For example, as shown in FIG. 1, the protective layer 150 may be interposed between the electrode layer 110 and the safety layer 155 while the safety layer 155 is further interposed between the protective layer 150 and the current collector 115.

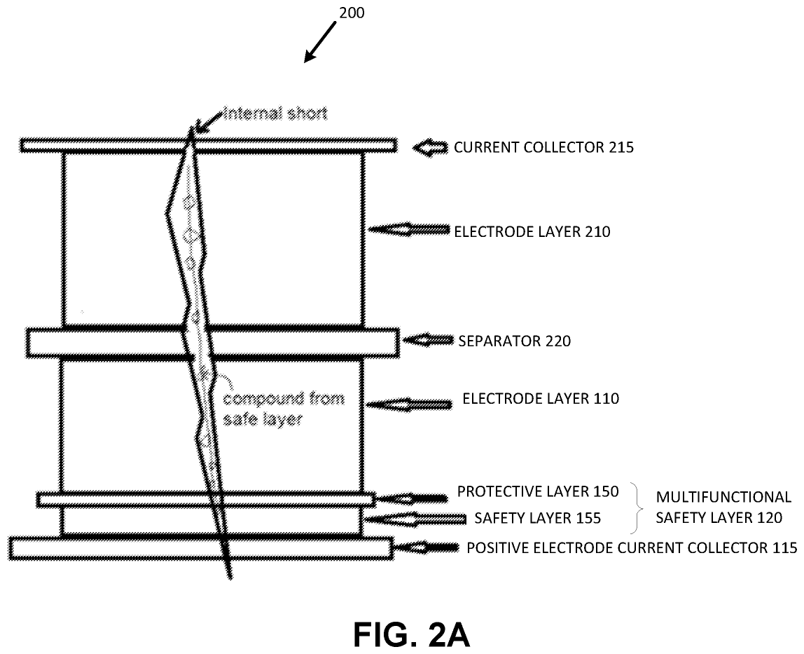

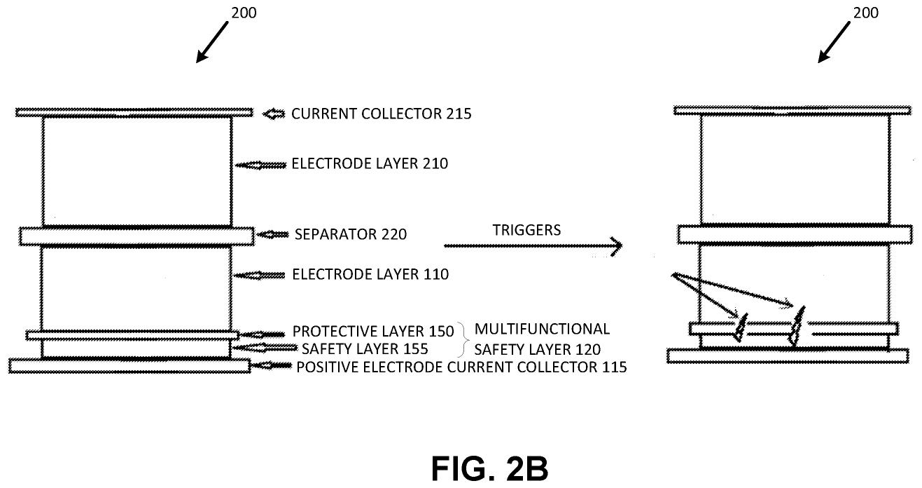

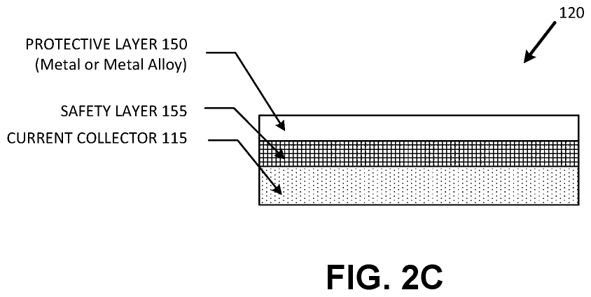

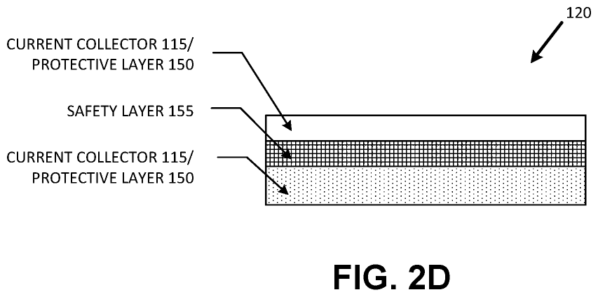

In some implementations of the current subject matter, the electrode 100 having the multifunctional safety layer 120 including the protective layer 150 and the safety layer 155 may be the positive electrode and/or the negative electrode of a battery cell. To further illustrate, FIG. 2A depicts a schematic diagram illustrating an example of a battery cell 200 including the electrode 100 as one electrode of the battery cell 200. In some cases, the battery cell 200 may be a metal battery cell or a metal ion battery cell including, for example, a lithium (Li) ion battery cell, a sodium (Na) ion battery cell, an aluminum (Al) ion battery cell, a magnesium (Mg) ion battery cell, and/or the like. Moreover, the battery cell 200 may be in any format including, for example, a cylindrical battery cell, a button battery cell, a prismatic battery cell, a pouch battery cell, and/or the like. Referring again to FIG. 2A, the battery cell 200 may include the first electrode layer 110 (e.g., the positive electrode layer) and a second electrode layer 210 of the opposite polarity (e.g., the negative electrode layer), and a separator 220 interposed therebetween. In some cases, the other electrode of the battery cell 200, which has an opposite polarity as the electrode 100, may include another multifunctional safety layer 120 interposed, for example, between the second electrode layer 210 and a second current collector 215. Alternatively, the other electrode of the battery cell 200 may omit the multifunctional safety layer 120 altogether or may include another one of the safety layer 155 but without the protective layer 150.

In some implementations of the current subject matter, the protective layer 150 forming the example of the multifunctional safety layer 120 shown in FIGS. 1 and 2 may be formed one or more materials that are inert in the presence of the reactive components of the battery cell 200 such as the electrodes (e.g., the first electrode layer 110, the second electrode layer 210), the electrolyte, and/or the like. In some cases, the materials forming the protective layer 150 may be electrically conductive. Examples of the materials forming the protective layer 150 may include poly (ethylene-co-vinyl acetate) (PECVA), styrene-butadiene rubber (SBR), Polytetrafluoroethylene (PTFE)), wax, silicon (Si) rubber, polyacrylic polymer, poly propylene, polyethylene, ethylene propylene diene monomer (EPDM) rubber and its analog, materials exhibiting a negative thermal expansion (NTE) coefficient (e.g., zinc cyanide (ZnCN₂) and/or the like), and materials that are reactive with the decomposition byproducts of electrolyte. Table 1 below lists additional examples of materials that may be used to form the protective layer 150.

TABLE 1

Tire rubber
Polyvinylidene fluoride (PVDF)
Polypropylene (PP atactic)
Polyvinyl fluoride (PVF)
Polypropylene (PP isotactic)
Poly-3-hydroxybutyrate (PHB)
Poly(vinyl acetate) (PVAc)
Polychlorotrifluoroethylene (PCTFE)
Polyamide (PA)

In some implementations of the current subject matter, the protective layer 150 is activated by one or more triggers including, for example, a temperature trigger, a voltage trigger, a current trigger, a physical damage to at least a portion of the battery cell 200 (or any components therein), and/or the like. FIG. 2B depicts a schematic diagram illustrating an example of the battery cell 200 in which the protective layer 150 has decomposed due to exposure to high temperature, high current, high voltage, and/or physical damage to at least a portion of the battery cell 200. In some cases, the protective layer 150 is activated when, for example, the temperature, current, and/or voltage of the battery cell 200 satisfies one or more thresholds (e.g., meet values associated with an overcharging, overheating, or short circuiting of the battery cell 200, exceed values associated with normal operation of the battery cell 200, and/or the like). In some cases, the one or more triggers may cause the protective layer 150 to decompose, disintegrate, and/or deform, thus exposing the safety layer 155 to the electrolyte and/or the electrode 110 of the battery cell 200. As noted, upon being exposed to the electrolyte and/or the electrode 110 of the battery cell 200, the safety layer 155 may become activated by the reaction between the exposed safety layer 155 and the electrolyte and/or the electrode 110 of the battery cell 200. The activation of the safety layer 155 which, in some cases, may further require another trigger (e.g., temperature, voltage, and/or current trigger), may neutralize hazardous operating conditions at the battery cell 200 such as overheating, overcharging, and/or internal short circuiting.

In cases where the protective layer 150 is formed from a metal foil or a metal alloy foil, the protective layer 150 may be activated only by physical damage such as a deformation and puncture of the protective layer 150. FIG. 2C depicts a schematic diagram illustrating an example of the multifunctional safety layer 120 in which the protective layer 150 is formed from a metal foil or a metal alloy foil (e.g., aluminum (Al) foil, copper (Cu) foil, titanium (Ti) foil, graphite (C) foil, graphene (C) foil, and/or the like). Alternatively, in some instances, the multifunctional safety layer 120 may be integrated with the current collector 115 of the battery cell 200. For example, in some cases, the protective layer 150 may be formed from a same type of metal (or metal alloy) as the current collector 115. FIG. 2D depicts a schematic diagram illustrating an example of the multifunctional safety layer 120 in which the safety layer 155 is interposed between two layers of metal (or metal alloy) foils, each layer of the metal (or metal alloy) foil serving as the protective layer 150 of the multifunctional safety layer 120 as well as the current collector 115 of the battery cell 200.

When formed from the metal foil and/or the metal alloy foil, the protective layer 150 may expose the safety layer 155 upon sustaining physical damage such as deformation and punctures. The safety layer 155 may be exposed, for example, to the electrolyte and/or the electrode 110 of the battery cell 200. This exposure may activate the safety layer 155 to neutralize hazardous operating conditions at the battery cell 200 such as overheating, overcharging, and/or internal short circuiting. For example, in some cases, the exposed safety layer 155 may react with the electrolyte and/or the electrode 110 of the battery cell 200 to neutralize hazardous operating conditions at the battery cell 200. In some cases, one or more additional triggers (e.g., temperature trigger, voltage trigger, current trigger, and/or the like) may be required to activate the exposed safety layer 155 to react with the electrolyte and/or the electrode 110 of the battery cell 200.

In instances where the protective layer 150 is formed from a material having a negative thermal expansion (NTE) coefficient, the shrinkage of the protective layer 150 when the multifunctional safety layer 120 is exposed to higher temperatures (e.g., temperatures exceeding certain thresholds) may expose the safety layer 155. Alternatively, in instances where the protective layer 150 is formed from materials that are prone to decompose at higher temperatures and/or voltages (e.g., temperatures and/or voltages exceeding certain thresholds), the safety layer 155 may become exposed when the multifunctional safety layer 120 is subjected to higher temperatures and/or voltages. Once the safety layer 155 is exposed to the electrolyte (or other reactive components of the battery cell 200), the reaction between the safety layer 155 and the electrolyte (or other reactive components of the battery cell 200) may neutralize hazardous operating conditions such as overheating, overcharging, and/or internal short circuiting.

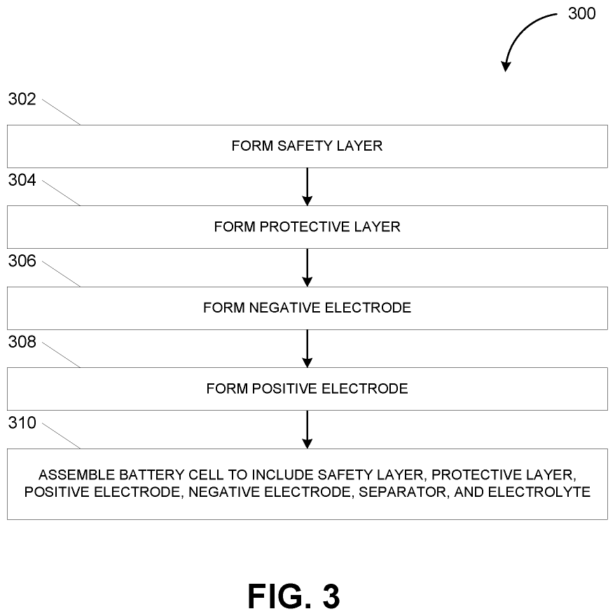

FIG. 3 depicts a flowchart illustrating an example of a process 300 for assembling a battery cell consistent with implementations of the current subject matter. Referring to FIG. 3, in some cases, the process 300 may be performed to assemble the battery cell 200 to include the multifunctional safety layer 120, which includes the protective layer 150 and the safety layer 155.

At 302, a safety layer may be formed. For example, in some cases, the safety layer 155 of the battery cell 200 may be formed from one or more of hydrates (e.g., lithium acetate dihydrate (CH₃COOLi2H₂O), sodium metasilicate hydrate (Na₂SiO₃·9H₂O), calcium chloride hydrate (CaCl₉H₂O), and/or the like), carbonates, fire extinguish agents, and organic salts with a below-threshold decomposition voltages or melting points (e.g., lithium (Li), sodium acetate (CH₃COONa), and/or the like).

At 304, a protective layer may be formed. In some cases, the protective layer 150 of the battery cell 200 may be formed from one or more of poly (ethylene-co-vinyl acetate) (PECVA), styrene-butadiene rubber (SBR), Polytetrafluoroethylene (PTFE)), wax, silicon (Si) rubber, polyacrylic polymer, poly propylene, polyethylene, ethylene propylene diene monomer (EPDM) rubber and its analog, tire rubber, polyvinylidene fluoride (PVDF), polypropylene (PP atactic), polyvinyl fluoride (PVF), polypropylene (PP isotactic), poly-3-hydroxybutyrate (PHB), poly(vinyl acetate) (PVAc), polychlorotrifluoroethylene (PCTFE), metal or metal alloy foil (e.g., aluminum (Al) foil, copper (Cu) foil, titanium (Ti) foil, graphite (C) foil, graphene (C) foil, and/or the like), conductive polymer film, polyamide (PA), materials exhibiting a negative thermal expansion (NTE) coefficient, and materials that are reactive with the decomposition byproducts of electrolyte.

At 306, a negative electrode may be formed. For example, the negative electrode layer 110 may be coated on the surface of the negative electrode current collector 115 before being dried, for example, at 140° C. for 10 hours. The negative electrode of the battery cell 200 may be further formed by being punched into appropriately shaped and/or sized pieces.

At 308, a positive electrode may be formed. For example, the positive electrode layer 210 may be coated on the surface of the positive electrode current collector before being dried, for example, at 125° C. for 10 hours. The positive electrode of the battery cell 200 may be further formed by being punched into appropriately shaped and/or sized pieces.

At 310, a battery cell may be assembled to include the safety layer, the protective layer, the negative electrode, the positive electrode, a separator, and an electrolyte. For example, the battery cell 200 may be formed to include the protective layer 150, the safety layer 155, the positive electrode layer 210, the positive electrode current collector 215, the negative electrode layer 110, the negative electrode current collector 115, and the separator 220. In instances where the battery cell 200 is a cylindrical cell, a layer of the separator 220 may be interposed between the positive electrode and the negative electrode of the battery cell 200 to form a sheet that is then wound, for example, around mandrel, to form a jellyroll before the jellyroll deposited inside a case. In instances where the battery cell 200 is a pouch cell, the positive electrode and the negative electrode may be stacked with a layer of the separator 200 interposed therebetween. One or more such stacks may then be deposited inside a pouch. The battery cell 200 may be filled with an electrolyte before being sealed, aged (e.g., room temperature for 24 hours), and subjected to one or more charging and discharging cycles (e.g., at a C/20 charging rate).

### Example I

In some implementations of the current subject matter, a safety layer with a water-based binder (e.g., CMC/SBR and/or the like) cannot be incorporated in an aqueous battery (e.g., an alkaline battery cell). This water-based safety layer may be protected with a protective layer configured to repel the aqueous electrolyte, thus preventing undesirable reactions that degrade the safety layer and/or cause a premature activation of the safety layer. This protective layer may be formed from a hydrophobic material (e.g., saturated hydrocarbon, wax-like substance, and/or the like) and without defects (e.g., pinholes, fissures, and/or the like) to prevent inadvertent exposure of the safety layer.

### Example II

In some implementations of the current subject matter, a safety layer containing a ceramic and/or a salt that is reactive when exposed to an electrolyte may be protected by a protective layer. Once the protective layer disintegrates (e.g., upon activation of a temperature trigger, a voltage trigger, a current trigger, and/or the like), the safety layer may become exposed and react with the electrolyte. The result may be a substitution reaction that would lead to a precipitation of the salt in the electrolyte. This salt precipitation may be accompanied by a reduction in the electrolyte's ionic conductivity, which can limit the discharge needed to trigger a thermal runaway event.

### Example III

In some implementations of the current subject matter, a safety layer containing a highly corrosive acid may become exposed to one or more electrodes in the battery cell upon disintegration of the protective layer (e.g., in response to a temperature trigger, a voltage trigger, a current trigger, and/or the like). This acid may etch an oxide-based cathode material to form a non-conductive gap between the cathode and current collector. Furthermore, the reaction between the acid and cathode may release water vapor and/or gas, which may increase contact impedance and eventually form a non-conductive gap between the cathode and current collector.

### Example IV: Protective Layer and Safety Layer on an Aluminum (Al) Positive Electrode Current Collector

In some implementations of the current subject matter, the safety layer 155 can be formed i) by dissolving 20 grams of sodium metasilicate hydrate (SMSH) in 200 grams of water; ii) 3 grams of carboxy methyl cellulose Sodium (CMC) was added to SMSH water solution and mixed it for 10 minutes by hand and aged it for 24 hours at room temperature; iii) 2 grams of carbon black was added to the slurry and mixed for 45 minutes at 3000 revolutions per minute or until a smooth slurry was made for the coating. The resulting slurry would be coated onto a 16-micrometer thickness aluminum (Al) foil using an automatic coating machine with multiple heating zones at approximately 75° C. to 100° C. The loading of the safety layer is approximately 0.3 mg/cm².

In some implementations of the current subject matter, the protective layer 150 can be formed i) by dissolving 20 grams of poly(ethylene-co-vinyl acetate) (PECVA) in 200 grams of ethylbenzene; ii) 2 grams of carbon black was added to the solution and mixed for 45 minutes at 3000 revolutions per minute or until a smooth slurry was made for the coating. The resulting slurry would be coated onto the top of safety layer 155 made above using an automatic coating machine with multiple heating zones at approximately 75° C. to 100° C. The loading of the safety layer is approximately 0.3 mg/cm². The protecting layer can be cross-linked by radiations like b-ray.

In some cases, the positive electrode of the battery cell 200 can be formed i) by dissolving 15 grams of PVDF (8% NMP solution) into 172.5 grams of n-Methylpyrrolidone (NMP); ii) adding 15 g carbon black to PVDF solution and mixed for 30 minutes at a rate of 5000 revolutions per minute. 970 grams of lithium nickel manganese cobalt oxide (NMC) was then added to the mixture and mixed for an additional 45 minutes at 5000 revolutions per minute. The resulting slurry can then be coated onto the surface of 16 um Al foil using an automatic coating machine with a heating zone between 85° C. to 135° C. The positive electrode loading is approximately 18 mg/cm². The electrode is calendared to 133 um.

In some implementations of the current subject matter, the negative electrode of the battery cell 200 can be formed i) by dissolving 14 grams of carboxymethyl cellulose (CMC) into 1077 grams of deionized water. The CMC mixture is then combined with 20 grams of carbon black for 15 minutes at a rate of approximately 5000 revolutions per minute. The mixture Is ten combined with 884 grams of synthetic graphite and mixed for 30 minutes at 5000 rotations per minute. In addition, 22 grams of styrene butadiene rubber (SBR) with a 50% solid content suspended in water can be added to the mixture and mixed for 5 minutes at 5000 revolutions per minute. The slurry is then coated onto 6 micrometer thickness copper (Cu) foil using an automatic coating machine with multiple heat zones ranging from 60° C. to 100° C. The negative electrode loading is 11 mg/cm². The electrode is calendared to about 150 μm.

In some implementations of the current subject matter, the battery cell 200 may be a 2 Ah pouch cell. The negative electrode layers 110 of the battery cell 200 may be cut into 34 mm by 58.5 mm rectangles while the positive electrode layers 210 of the battery cell 200 may be cut into 33 mm by 57.5 mm rectangles. Sixteen pieces of positive electrode layers 210 and seventeen pieces of negative electrode layers 110 may be stacked together with layers of the separator 220 (e.g., 25 μm thick ND525 separator (Asahi Kasei)). The battery cell 200 may be filled with 4.25 mL of standard carbonate-based electrolyte. The battery cell 200 may then be aged at room temperature for 24 hours before being formed with a C/20 charging rate.

### Example V: Protective Layer and Safety Layer on a Copper (Cu) Negative Electrode Current Collector

In some implementations of the current subject matter, the safety layer 155 may be formed i) by dissolving 20 grams of sodium metasilicate hydrate (SMSH) in 200 grams of water; ii) 3 grams carboxy methyl cellulose Sodium (CMC) was added to SMSH water solution and mixed it for 10 minutes by hand and aged it for 24 hours at room temperature; iii) 2 grams of carbon black was added to the slurry and mixed for 45 minutes at 3000 revolutions per minute or until a smooth slurry was made for the coating. The resulting slurry would be coated onto a 6-micrometer thickness copper (Cu) foil using an automatic coating machine with multiple heating zones at approximately 75° C. to 100° C. The loading of the safety layer 155 is approximately 0.3 mg/cm².

In some cases, the protective layer 150 can be formed i) by dissolving 20 grams of poly(ethylene-co-vinyl acetate) (PECVA) in 200 grams of ethylbenzene; ii) 2 grams of carbon black was added to the solution and mixed for 45 minutes at 3000 revolutions per minute or until a smooth slurry was made for the coating. The resulting slurry would be coated onto the top of safety layer 155 made above using an automatic coating machine with multiple heating zones at approximately 75° C. to 100° C. The loading of the safety layer is approximately 0.3 mg/cm².

In some implementations of the current subject matter, the negative electrode of the battery cell 200 can be formed i) by dissolving 14 grams of carboxymethyl cellulose (CMC) into 1077 grams of deionized water. The CMC mixture is then combined with 20 grams of carbon black for 15 minutes at a rate of approximately 5000 revolutions per minute. The mixture Is ten combined with 884 grams of synthetic graphite and mixed for 30 minutes at 5000 rotations per minute. In addition, 22 grams of styrene butadiene rubber (SBR) with a 50% solid content suspended in water and 3 grams of lithium neutralized polyimide can be added to the mixture and mixed for 5 minutes at 5000 revolutions per minute. The slurry is then coated onto the surface of the safety layer protective layer using an automatic coating machine with multiple heat zones ranging from 60° C. to 100° C. The negative electrode loading is 11 mg/cm². The electrode is calendared to about 160 μm.

In some cases, the positive electrode of the battery cell 200 can be formed i) by dissolving 15 grams of PVDF (8% NMP solution) into 172.5 grams of n-Methylpyrrolidone (NMP); ii) adding 15 g carbon black to PVDF solution and mixed for 30 minutes at a rate of 5000 revolutions per minute. 970 grams of lithium nickel manganese cobalt oxide (NMC) was then added to the mixture and mixed for an additional 45 minutes at 5000 revolutions per minute. The resulting slurry can then be coated onto the surface of 16 μm Al foil using an automatic coating machine with a heating zone between 85° C. to 135° C. The positive electrode loading is approximately 18 mg/cm². The electrode is calendared to 123 μm.

In some implementations of the current subject matter, the battery cell 200 may be a 2 Ah pouch cell. The negative electrode layers 110 of the battery cell 200 may be cut into 34 mm by 58.5 mm rectangles while the positive electrode layers 210 of the battery cell 200 may be cut into 33 mm by 57.5 mm rectangles. Sixteen pieces of positive electrode layers 210 and seventeen pieces of negative electrode layers 110 may be stacked together with layers of the separator 220 (e.g., 25 μm thick ND525 separator (Asahi Kasei)). The battery cell 200 may be filled with 4.25 mL of standard carbonate-based electrolyte. The battery cell 200 may then be aged at room temperature for 24 hours before being formed with a C/20 charging rate.

### Example VI: Protective Layer and Safety Layer on an Aluminum (Al) Positive Electrode Current Collector and a Copper (Cu) Negative Electrode Current Collector

In some implementations of the current subject matter, the safety layer 155 may be formed i) by dissolving 20 grams of sodium metasilicate hydrate (SMSH) in 200 grams of water; ii) 3 grams of carboxy methyl cellulose Sodium (CMC) was added to SMSH water solution and mixed it for 10 minutes by hand and aged it for 24 hours at room temperature; iii) 2 grams of carbon black was added to the slurry and mixed for 45 minutes at 3000 revolutions per minute or until a smooth slurry was made for the coating. The resulting slurry would be coated onto a 6 micrometer thickness copper (Cu) foil using an automatic coating machine with multiple heating zones at approximately 75° C. to 100° C. The loading of the safety layer is approximately 0.3 mg/cm².

In some implementations of the current subject matter, the protective layer 150 can be formed i) by dissolving 20 grams of poly(ethylene-co-vinyl acetate) (PECVA) in 200 grams of ethylbenzene; ii) 2 grams of carbon black was added to the solution and mixed for 45 minutes at 3000 revolutions per minute or until a smooth slurry was made for the coating. The resulting slurry would be coated onto the top of safety layer 155 made above using an automatic coating machine with multiple heating zones at approximately 75° C. to 100° C. The loading of the safety layer 155 is approximately 0.3 mg/cm².

In some implementations of the current subject matter, the negative electrode of the battery cell 200 can be formed i) by dissolving 14 grams o carboxymethyl cellulose (CMC) into 1077 grams of deionized water. The CMC mixture is then combined with 20 grams of carbon black for 15 minutes at a rate of approximately 5000 revolutions per minute. The mixture Is ten combined with 884 grams of synthetic graphite and mixed for 30 minutes at 5000 rotations per minute. In addition, 22 grams of styrene butadiene rubber (SBR) with a 50% solid content suspended in water and 3 grams of lithium neutralized polyimide can be added to the mixture and mixed for 5 minutes at 5000 revolutions per minute. The slurry is then coated onto the surface of the safety layer protective layer using an automatic coating machine with multiple heat zones ranging from 60° C. to 100° C. The negative electrode loading is 11 mg/cm². The electrode is calendared to about 160 μm.

In some cases, another one of the safety layer 155 can be formed i) by dissolving 20 grams of sodium metasilicate hydrate (SMSH) in 200 grams of water; ii) 3 grams of carboxy methyl cellulose Sodium (CMC) was added to SMSH water solution and mixed it for 10 minutes by hand and aged it for 24 hours at room temperature; iii) 2 grams of carbon black was added to the slurry and mixed for 45 minutes at 3000 revolutions per minute or until a smooth slurry was made for the coating. The resulting slurry would be coated onto a 16-micrometer thickness aluminum (Al) foil using an automatic coating machine with multiple heating zones at approximately 75° C. to 100° C. The loading of the safety layer 155 is approximately 0.3 mg/cm².

In some cases, another one of the protective layer 150 can be formed i) by dissolving 20 grams of poly(ethylene-co-vinyl acetate) (PECVA) in 200 grams of ethylbenzene; ii) 2 grams of carbon black was added to the solution and mixed for 45 minutes at 3000 revolutions per minute or until a smooth slurry was made for the coating. The resulting slurry would be coated onto the top of safety layer 155 made above using an automatic coating machine with multiple heating zones at approximately 75° C. to 100° C. The loading of the protective layer 150 is approximately 0.3 mg/cm².

In some instances, the positive electrode of the battery cell 200 can be formed i) by dissolving 15 grams of PVDF (8% NMP solution) into 172.5 grams of n-Methylpyrrolidone (NMP); ii) adding 15 g carbon black to PVDF solution and mixed for 30 minutes at a rate of 5000 revolutions per minute. 970 grams of lithium nickel manganese cobalt oxide (NMC) was then added to the mixture and mixed for an additional 45 minutes at 5000 revolutions per minute. The resulting slurry can then be coated onto the surface of 16 μm Al foil using an automatic coating machine with a heating zone between 85° C. to 135° C. The positive electrode loading is approximately 18 mg/cm². The electrode is calendared to 133 μm.

In some implementations of the current subject matter, the battery cell 200 may be a 2 Ah pouch cell. The negative electrode layers 110 of the battery cell 200 may be cut into 34 mm by 58.5 mm rectangles while the positive electrode layers 210 of the battery cell 200 may be cut into 33 mm by 57.5 mm rectangles. Sixteen pieces of positive electrode layers 210 and seventeen pieces of negative electrode layers 110 may be stacked together with layers of the separator 220 (e.g., 25 μm thick ND525 separator (Asahi Kasei)). The battery cell 200 may be filled with 4.25 mL of standard carbonate-based electrolyte. The battery cell 200 may then be aged at room temperature for 24 hours before being formed with a C/20 charging rate.

### Example VII: Protective Layer with Emulsion SBR (Styrene-Butadiene Rubber) on an Aluminum (Al) the Positive Electrode Current Collector

In some implementations of the current subject matter, the safety layer 155 can be formed i) by dissolving 20 grams of sodium metasilicate hydrate (SMSH) in 200 grams of water; ii) 3 grams of carboxy methyl cellulose Sodium (CMC) was added to SMSH water solution and mixed it for 10 minutes by hand and aged it for 24 hours at room temperature; iii) 2 grams of carbon black was added to the slurry and mixed for 45 minutes at 3000 revolutions per minute or until a smooth slurry was made for the coating. The resulting slurry would be coated onto a 16-micrometer thickness aluminum (Al) foil using an automatic coating machine with multiple heating zones at approximately 75° C. to 100° C. The loading of the safety layer 155 is approximately 0.3 mg/cm².

In some implementations of the current subject matter, the protective layer 150 can be formed i) by dissolving 2 grams of CMC in 100 grams of water; ii) 2 grams of carbon black was added to the solution and mixed for 45 minutes at 3000 revolutions per minute or until a smooth slurry was made for the coating; iii) Add 40 g of SBR (105 A) suspension solution (40.3% solid content). The resulting slurry would be coated onto the top of safety layer 155 made above using an automatic coating machine with multiple heating zones at approximately 75° C. to 100° C. The loading of the protective layer 150 is approximately 0.3 mg/cm².

In some implementations of the current subject matter, the positive electrode of the battery cell can be formed i) by dissolving 15 grams of PVDF (8% NMP solution) into 172.5 grams of n-Methylpyrrolidone (NMP); ii) adding 15 grams of carbon black to PVDF solution and mixed for 30 minutes at a rate of 5000 revolutions per minute. 970 grams of lithium nickel manganese cobalt oxide (NMC) was then added to the mixture and mixed for an additional 45 minutes at 5000 revolutions per minute. The resulting slurry can then be coated onto the surface of 16 μm Al foil using an automatic coating machine with a heating zone between 85° C. to 135° C. The positive electrode loading is about 18 mg/cm². The electrode is calendared to 133 μm.

In some implementations of the current subject matter, the negative electrode of the battery cell 200 can be formed i) by dissolving 14 grams of carboxymethyl cellulose (CMC) into 1077 grams of deionized water. The CMC mixture is then combined with 20 grams of carbon black for 15 minutes at a rate of approximately 5000 revolutions per minute. The mixture is then combined with 884 grams of synthetic graphite and mixed for 30 minutes at 5000 rotations per minute. In addition, 22 grams of styrene butadiene rubber (SBR) with a 50% solid content suspended in water and 3 grams of lithium neutralized polyimide can be added to the mixture and mixed for 5 minutes at 5000 revolutions per minute. The slurry is then coated onto 6 micrometer thickness copper (Cu) foil using an automatic coating machine with multiple heat zones ranging from 60° C. to 100° C. The negative electrode loading is 11 mg/cm². The electrode is calendared to about 150 μm.

In some implementations of the current subject matter, the battery cell 200 may be a 2 Ah pouch cell. The negative electrode layers 110 of the battery cell 200 may be cut into 34 mm by 58.5 mm rectangles while the positive electrode layers 210 of the battery cell 200 may be cut into 33 mm by 57.5 mm rectangles. Sixteen pieces of positive electrode layers 210 and seventeen pieces of negative electrode layers 110 may be stacked together with layers of the separator 220 (e.g., 25 μm thick ND525 separator (Asahi Kasei)). The battery cell 200 may be filled with 4.25 mL of standard carbonate-based electrolyte. The battery cell 200 may then be aged at room temperature for 24 hours before being formed with a C/20 charging rate.

### Example VII: Baseline Battery Cell without Protective Layer

In some cases, the positive electrode of a baseline battery cell can be formed i) by dissolving 15 grams of PVDF (8% NMP solution) into 172.5 grams of n-Methylpyrrolidone (NMP); ii) adding 15 g carbon black to PVDF solution and mixed for 30 minutes at a rate of 5000 revolutions per minute. 970 grams of lithium nickel manganese cobalt oxide (NMC) was then added to the mixture and mixed for an additional 45 minutes at 5000 revolutions per minute. The resulting slurry can then be coated onto the surface of 16 μm Al foil using an automatic coating machine with a heating zone between 85° C. to 135° C. The positive electrode loading is about 18 mg/cm². The electrode is calendared to 123 μm.

In some cases, the negative electrode of the baseline battery cell can be formed i) by dissolving 14 grams of carboxymethyl cellulose (CMC) into 1077 grams of deionized water. The CMC mixture is then combined with 20 grams of carbon black for 15 minutes at a rate of approximately 5000 revolutions per minute. The mixture Is ten combined with 884 grams of synthetic graphite and mixed for 30 minutes at 5000 rotations per minute. In addition, 22 grams of styrene butadiene rubber (SBR) with a 50% solid content suspended in water and 3 grams of lithium neutralized polyimide can be added to the mixture and mixed for 5 minutes at 5000 revolutions per minute. The slurry is then coated onto 6 micrometer thickness copper (Cu) foil using an automatic coating machine with multiple heat zones ranging from 60° C. to 100° C. The negative electrode loading is 11 mg/cm². The electrode is calendared to about 150 μm.

In some implementations of the current subject matter, the baseline battery cell may be a 2 Ah pouch cell. The negative electrode layers of the baseline battery cell may be cut into 34 mm by 58.5 mm rectangles while the positive electrode layers of the baseline battery cell may be cut into 33 mm by 57.5 mm rectangles. Sixteen pieces of positive electrode layers and seventeen pieces of negative electrode layers may be stacked together with layers of a separator (e.g., 25 μm thick ND525 separator (Asahi Kasei)). The baseline battery cell may be filled with 4.25 mL of standard carbonate-based electrolyte. The baseline battery cell may then be aged at room temperature for 24 hours before being formed with a C/20 charging rate.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A battery cell, comprising:
an electrolyte;
a first electrode including a first electrode layer and a first current collector, the first electrode further include a first protective layer and a first safety layer, the first protective layer interposed between the first electrode layer and the first safety layer, the first safety layer interposed between the first protective layer and the first current collector, the first safety layer configured to respond to a first trigger by at least interrupting a current flow within the battery cell, and the first protective layer configured to prevent a reaction between the first safety layer and the electrolyte and/or the first electrode layer of the battery cell until the first protective layer is activated by a second trigger;
a second electrode including a second electrode layer and a second current collector; and
a separator interposed between the first electrode and the second electrode.

2. The battery cell of claim 1, wherein the second electrode further includes a second safety layer configured to respond to the first trigger by at least interrupting the current flow within the battery cell, and wherein the second electrode further includes a second protective layer configured to prevent a reaction between the second safety layer and the electrolyte and/or the second electrode layer of the battery cell until the second protective layer is activated by the second trigger.

3. The battery cell of claim 2, wherein the second protective layer is interposed between the second electrode layer and the second safety layer, and wherein the second safety layer interposed between the second protective layer and the second current collector.

4. The battery cell of claim 1, wherein the first protective layer is configured to respond to the second trigger by at least exposing the first safety layer to the electrolyte and/or the first electrode layer of the battery cell, and wherein the first safety layer is further configured to interrupt the current flow within the battery cell upon being exposed to the electrolyte and/or the first electrode layer of the battery cell.

5. The battery cell of claim 4, wherein the first safety layer undergoes a reaction with the electrolyte and/or the first electrode layer of the battery cell upon being exposed to the electrolyte and/or the first electrode layer of the battery cell.

6. The battery cell of claim 5, wherein the reaction includes a physical reaction in which the first safety layer expands to create a nonconductive gap between the first electrode layer and the first current collector that interrupts the current flow within the battery cell.

7. The battery cell of claim 5, wherein the reaction includes a chemical reaction in which the first safety layer decomposes to create a nonconductive gap between the first electrode layer and the first current collector that interrupts the current flow within the battery cell.

8. The battery cell of claim 5, wherein the reaction includes a chemical reaction in which an ionic conductivity of the electrolyte is lowered to interrupt the current flow within the battery cell.

9. The battery cell of claim 1, wherein at least a portion of the first protective layer is configured to decompose in response to the second trigger, and wherein the first safety layer is exposed to the electrolyte and/or the first electrode layer of the battery cell when at least the portion of the first protective layer decomposes in response to the second trigger.

10. The battery cell of claim 1, wherein at least a portion of the first protective layer is configured to shrink in response to the second trigger, and wherein the first safety layer is exposed to the electrolyte and/or the first electrode layer of the battery cell when at least the portion of the first protective layer shrinks in response to the second trigger.

11. The battery cell of claim 1, wherein the first trigger comprises a different trigger or a trigger having a different threshold than the second trigger.

12. The battery cell of claim 1, wherein the first trigger and the second trigger each comprise a temperature trigger, a voltage trigger, a current trigger, or a physical damage to the battery cell.

13. The battery cell of claim 1, wherein the second trigger is a physical damage to the first protective layer, and wherein the first trigger is a temperature trigger, a voltage trigger, and/or a current trigger.

14. The battery cell of claim 1, wherein the first protective layer is formed from one or more of poly (ethylene-co-vinyl acetate) (PECVA), styrene-butadiene rubber (SBR), Polytetrafluoroethylene (PTFE)), wax, silicon (Si) rubber, polyacrylic polymer, poly propylene, polyethylene, ethylene propylene diene monomer (EPDM) rubber and its analog, tire rubber, polyvinylidene fluoride (PVDF), polypropylene (PP atactic), polyvinyl fluoride (PVF), polypropylene (PP isotactic), poly-3-hydroxybutyrate (PHB), poly(vinyl acetate) (PVAc), polychlorotrifluoroethylene (PCTFE), polyamide (PA), metal foil, metal alloy foil, conductive polymer film, materials exhibiting a negative thermal expansion (NTE) coefficient, and materials that are reactive with the decomposition byproducts of electrolyte.

15. The battery cell of claim 1, wherein the first electrode is a positive electrode of the battery cell, and wherein the second electrode is a negative electrode of the battery cell.

16. The battery cell of claim 1, wherein the first current collector is an aluminum (Al) current collector, and wherein the second current collector is a copper (Cu) current collector.

17. The battery cell of claim 1, wherein the first safety layer includes one or more of a hydrate, a carbonate, a fire extinguishing agent, and an organic salt exhibiting a below-threshold decomposition voltage and/or melting point.

18. The battery cell of claim 1, wherein the first safety layer includes one or more of lithium acetate dihydrate (CH₃COOLi2H₂O), sodium metasilicate hydrate (Na₂SiO₃·9H₂O), and calcium chloride hydrate (CaCl₉H₂O).

19. The battery cell of claim 1, wherein the battery cell is a lithium (Li) ion battery cell, a sodium (Na) ion battery cell, an aluminum (Al) ion battery cell, or a magnesium (Mg) ion battery cell.

20. The battery cell of claim 1, wherein the battery cell is a cylindrical battery cell, a button battery cell, a prismatic battery cell, or a pouch battery cell.
